(19) United States
(12) Patent Application Publication
(10) Pub. No.: US 2005/0213562 A1
(43) Pub. Date: Sep. 29, 2005

(54) TELECOMMUNICATION SYSTEM AND METHOD FOR ROUTING DATA OF AN IP-BASED PBX EXTENSION TO A HOST

(76) Inventor: Heng-Chien CHEN, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,763

(22) Filed: Mar. 24, 2004

(51) Int. Cl. H04L 12/66

(52) U.S. Cl. 370/352

(57) ABSTRACT

A method and a telecommunication system of routing data of an IP-based PBX extension to a host. The method of routing a data of an IP-based PBX extension to a host includes driving the IP-based PBX extension to request a virtual IP address from an IP sharing device, driving the IP-based PBX extension having the virtual IP address to output a packet having the data through the IP sharing device, utilizing a sender with a first IP address to deliver the packet received from the IP sharing device to the host with a second IP address through a computer network, and utilizing the host to extract the data from the packet.

### BACKGROUND OF INVENTION

1. Field of the Invention

The present invention relates to a method and a telecommunication system for routing data between a telecommunication extension and a telecommunication host, and more particularly, to a method and a telecommunication system for routing data between an IP-based PBX extension and a host through wired communication or wireless communication.

2. Description of the Prior Art

With the popularity of Internet connections, many IP-based applications are developed to provide users Internet connections anytime and anywhere. For example, Voice over Internet Protocol (VoIP) systems are developed to transmit voice efficiently over the Internet. In the prior art, each terminal in VoIP systems connects to the Internet through a physical IP address, which is provided by an Internet Service Provider (ISP). However, voice packets are transmitted through the physical IP addresses in peer-to-peer way, which lacks flexibility of network mechanism to transmit voice packets through the Internet.

Concerning a local VoIP system built within a building, each VoIP terminal (e.g. a PBX extension) with a specific ID (e.g. a predetermined IP address) can be successfully identified by a host of the local VoIP system. In other words, the host is capable of arbitrating data transmission between two local PBX extensions. However, if one prior art PBX extension originally acknowledged by the host of the local VoIP system is moved to another telecommunication system, the PBX extension is unable to work properly for exchanging voice packets with the host the local VoIP system because the required connection between the host and the PBX extension is broken. Therefore, if the prior art PBX extension roams through other telecommunication systems instead of the local VoIP system, a user can not make use of the prior art PBX extension to communicate with a user utilizing a prior art PBX extension connected to the local VoIP system.

### SUMMARY OF INVENTION

It is therefore a primary objective of the claimed invention to provide a method and a telecommunication system of routing data of an IP-based PBX extension to a host to solve the above-mentioned problem.

According to the claimed invention, a method of routing a data of an IP-based PBX extension to a host comprises driving the IP-based PBX extension to request a virtual IP address from an IP sharing device, driving the IP-based PBX extension having the virtual IP address to output a packet having the data through the IP sharing device, utilizing a sender with a first IP address to deliver the packet received from the IP sharing device to the host with a second IP address through a computer network, and utilizing the host to extract the data from the packet.

In addition, the claimed invention provides a telecommunication system including an IP sharing device for providing a virtual IP address, an IP-based PBX extension electrically connected to the IP sharing device for requesting the virtual IP address from the IP sharing device, wherein the IP-based PBX extension having the virtual IP address is capable of outputting a packet having the data through the IP sharing device, a host, and a sender electrically connected to the IP sharing device, the sender with a first IP address capable of delivering the packet received from the IP sharing device to the host with a second IP address through a computer network, wherein the host extracts the data from the packet.

It is an advantage of the claimed invention that the method and the telecommunication system can transmit voice packets to the Internet through virtual IP addresses requested from IP sharing devices. The virtual IP addresses provided by the IP sharing device are cheaper than the physical IP addresses provided by the ISP. The IP-based PBX extensions can be connected to the local host through wires according to the IEEE 802.3 protocol or be wirelessly connected to the local host through the APs according to the IEEE 802.11x protocol. In addition, the IP-based PBX extensions can also be connected to the remote host through Internet with virtual IP addresses provided by the IP sharing device. Thus, the method and the telecommunication system according to the present invention greatly improve flexibility of prior art VoIP systems through transmitting voice packets efficiently via the Internet with the help of the virtual IP addresses.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a telecommunication system according to the present invention.

FIG. 2 is a flow chart illustrating operation of the telecommunication system shown in FIG. 1.

### DETAILED DESCRIPTION

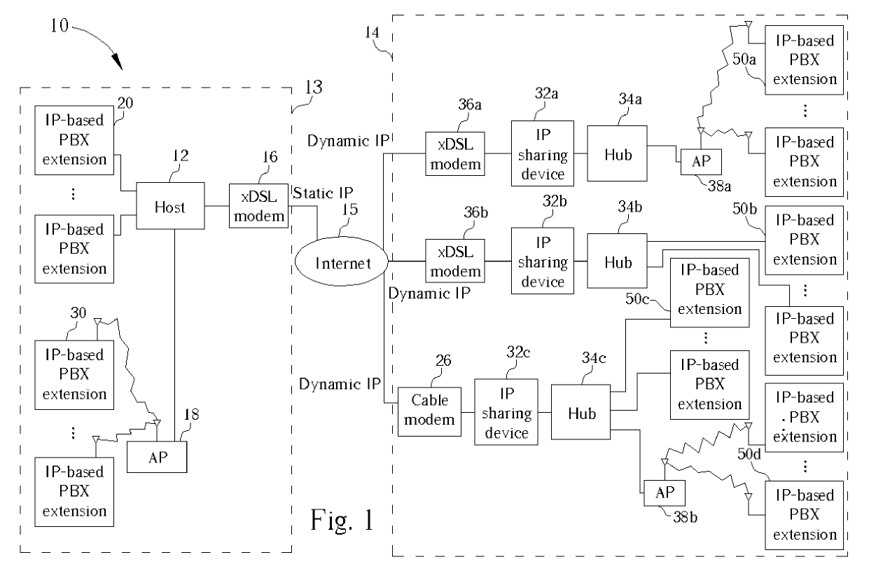

Please refer to FIG. 1. FIG. 1 is a block diagram of a telecommunication system 10 according to the present invention. The telecommunication system 10 includes a host 12 for arbitrating data (for example, voice packets) transmitted among a plurality of IP-based PBX extensions 20, 30, 50a, 50b, 50c, 50d, wherein the IP-based PBX extensions 20, 30 are positioned within a local domain 13, and the IP-based PBX extensions 50a, 50b, 50c, 50d are positioned within a remote domain 14. The IP-based PBX extensions within the local domain 13 are directly handled by the host 12. The IP-based PBX extensions within the remote domain 14, however, are indirectly handled by the host 12 with the help of the Internet 15. As shown in FIG. 1, the host 12 is connected to the Internet 15 through an Internet connection device, which provides a static IP address to connect the Internet 15. The Internet connection device is an xDSL modem 16. However, other broad-band Internet connection devices such as the cable modem can be used to be the above-mentioned Internet connection device. For the local domain 13, a plurality of the IP-based PBX extensions 20 are connected to the host 12 through cables, and a plurality of the IP-based PBX extensions 30 are wirelessly connected to the host 12 through an access point (AP) 18.

In addition, the telecommunication system 10 in the preferred embodiment further has a plurality of IP sharing devices 32a, 32b, 32c, a plurality of Internet connections such as xDSL modems 36a, 36b and a cable modem 26, a plurality of Hubs 34a, 34b, 34c, and a plurality of APs 38a, 38b. The xDSL modems 36a, 36b and the cable modem 26 respectively utilize a plurality of dynamic IP addresses to connect the Internet 15. As shown in FIG. 1, these IP extensions 50a are wirelessly connected to the IP sharing device 32a through the AP 38a and the Hub 34a. Similarly, these IP-based PBX extensions 50d are wirelessly connected to the IP sharing device 32c through the AP 38b and the Hub 34c. For other IP-based PBX extensions 50b, 50c, they are respectively connected to the IP sharing devices 32b, 32c through the corresponding Hubs 34b, 34c wired to the IP-based PBX extensions 50b, 50c.

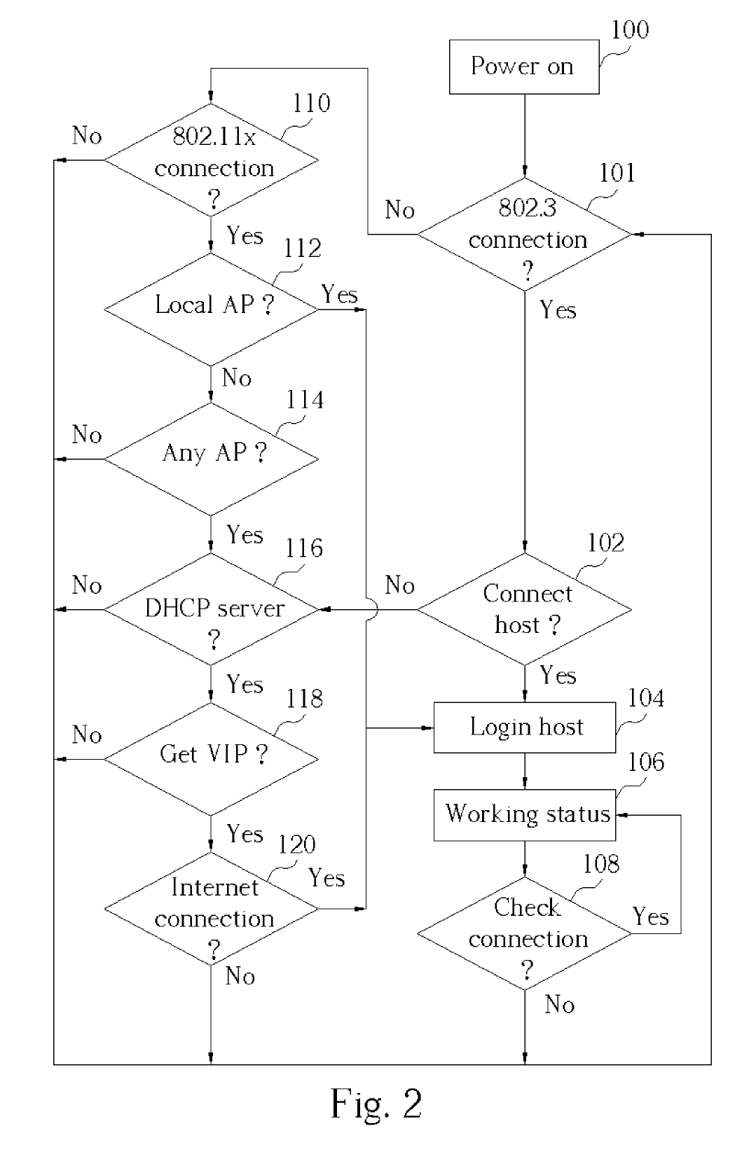

Before a source IP-based PBX extension is capable of transferring voice packets to a target IP-based PBX extension acknowledged by the host 12, the source IP-based PBX extension is needed to be acknowledged by the host 12. That is, the source IP-based PBX extension has to login the host 12 when the source IP-based PBX extension is activated. Please refer to FIG. 2. FIG. 2 is the flow chart illustrating operation of the telecommunication system 10 shown in FIG. 1. The operation includes following steps:

Step 100: Power on an IP-based PBX extension;

Step 101: The IP-based PBX extension checks if a wired network port is connected according to an IEEE 802.3 protocol. If yes, go to step 102; otherwise, go to step 110;

Step 102: The IP-based PBX extension checks if the host 12 is directly accessible. If yes, go to step 104; otherwise, go to step 116;

Step 104: The IP-based PBX extension login the host 12;

Step 106: The IP-based PBX extension enters a working status, and starts performing its designed functionality;

Step 108: The IP-based PBX extension checks if the connection between the host 12 and the IP-based PBX extension is still available. If yes, go to step 106; otherwise, go to step 101;

Step 110: The IP-based PBX extension checks if a wireless network port is connected according to an IEEE 802.11x protocol. If yes, go to step 112; otherwise, return to step 101;

Step 112: The IP-based PBX extension checks if a local AP used by the host 12 is available. If yes, go to step 104; otherwise, go to step 114;

Step 114: The IP-based PBX extension checks if an AP not used by the host 12 is available. If yes, go to step 116; otherwise, go to step 101;

Step 116: The IP-based PBX extension checks if an IP sharing device such as a dynamic host configuration protocol (DHCP) server or a network address translation (NAT) server is available. If yes, go to step 118; otherwise, return to step 101;

Step 118: The IP-based PBX extension tries to ask the IP sharing device for a virtual IP. The IP-based PBX extension checks if the virtual IP address allocated by the IP sharing device is successfully received. If yes, go to step 120; otherwise, return to step 101; and

Step 120: The IP-based PBX extension tries to enter the Internet 15 through the virtual IP address. The IP-based PBX extension checks if a connection between the IP-based PBX extension and the host 12 is successfully established. If yes, go to step 104; otherwise, return to step 101.

The operation of the telecommunication system 10 is described as follows. For each of the IP-based PBX extensions 20, 30, 50a, 50b, 50c, 50d, it has a wired network port for accessing a wired network and a wireless communication module for accessing a wireless network. Taking the IP-based PBX extension 50c, 50d in the remote domain 14 for example, the IP-based PBX extension 50c can be electrically connected to the Hub 34c through a cable, and the IP-based PBX extension 50d can be electrically connected to the Hub 34c through a wireless connection between the AP 38b and the IP-based PBX extension 50d and a wired connection between the AP 38b and the Hub 34c. Suppose that the IP-based PBX extension 50d within the remote domain 14 is powered on (step 100). Then, the IP-based PBX extension 50d finds out that no cable is connected to the wired network port (step 102). Therefore, a process for building a connection between the IP-based PBX extension 50d and the host 12 according to the IEEE 802.3 protocol is unable to work. Then, the IP-based PBX extension 50d checks if the local AP 18 used by the host 12 is accessible through the IEEE 802.11x protocol (step 112). It is clear that the IP-based PBX extension 50d is positioned within the remote domain 14 and is far away from the AP 18. The IP-based PBX extension 50d, therefore, is unable to locate the wanted AP 18.

In the preferred embodiment, the IP-based PBX extension 50d starts searching any available APs around the IP-based PBX extension 50d (step 114). As shown in FIG. 1, the AP 38b is close to the IP-based PBX extension 50d, and is available to the IP-based PBX extension 50d. Therefore, the wireless connection is successfully built between the IP-based PBX extension 50d and the AP 38b. Then, the IP-based PBX extension 50d finds an available IP shearing device 32c, and starts requesting for a virtual IP address (steps 116, 118). After the wanted virtual IP address is successfully assigned to the IP-based PBX extension 50d, the IP-based PBX extension 50d tries to enter the Internet 15 (step 120). If the IP-based PBX extension 50d has been correctly connected to the Internet 15 through the Hub 34c, the IP sharing device 32c, and the cable modem 26, the IP-based PBX extension 50d is capable of accessing the host 12. That is, the IP-based PBX extension 50d performs step 104 to login the host 12 (step 104). After the IP-based PBX extension 50d is fully acknowledged by the host 12, the IP-based PBX extension 50d starts performing its designed function for delivering voice packets (step 106). In the end, the IP-based PBX extension 50d located within the remote domain 14 communicates with the host 12 and works normally with the help of the virtual IP address provided by the IP sharing device 32c.

Consider that the IP-based PBX extension 50b instead of the IP-based PBX extension 50d is powered on (step 100). Under this situation, the IP-based PBX extension 50b finds out that a cable is electrically connected to the wired network port through the IEEE 802.3 protocol (step 102). Therefore, the IP-based PBX extension 50b begins checking if the host 12 is directly available (step 102). As shown in FIG. 1, the IP-based PBX extension 50b is located within the remote domain 14 instead of the local domain 13. In other words, the IP-based PBX extension 50b is unable to directly access the host 12 through the cable connected to the wired network port. Then, the IP-based PBX extension 50b finds an available IP shearing device 32b, and starts requesting for a virtual IP address (steps 116, 118). After the wanted virtual IP address is successfully assigned to the IP-based PBX extension 50b, the IP-based PBX extension 50b tries to enter the Internet 15 (step 120). If the IP-based PBX extension 50d has been correctly connected to the Internet 15 through the Hub 34b, the IP sharing device 32b, and the xDSL modem 36b, the IP-based PBX extension 50b is capable of accessing the host 12. That is, the IP-based PBX extension 50b performs step 104 to login the host 12 (step 104). After the IP-based PBX extension 50b is fully acknowledged by the host 12, the IP-based PBX extension 50b starts performing its designed function for delivering voice packets (step 106). In the end, the IP-based PBX extension 50b located within the remote domain 14 communicates with the host 12 and works normally with the help of the virtual IP address provided by the IP sharing device 32b.

In addition, when the IP-based PBX extensions 50a, 50b, 50c, 50d transmit voice data to the host 12 corresponding to a static IP address through the Internet 15, the IP-based PBX extensions 50a, 50b, 50c, 50d will add corresponding virtual IP addresses to the voice data. Taking the IP-based PBX extension 50a for example, the voice data outputted from the IP-based PBX extension 50a includes identification information. The voice packets containing the voice data generated from the IP-based PBX extension 50a are then transmitted via the Internet 15. Please note that when a voice packet is outputted from the xDSL modem 36a, each of the voice packets includes the virtual IP address of the IP-based PBX extension 50a, the dynamic IP address of the xDSL 36a, and the static IP address of the xDSL modem 16. Therefore, the voice packets are received by the xDSL modem 16 through the static IP address recorded in each voice packet corresponding to the IP-based PBX extension 50a. Thus, the host 12 extracts the identification information from the voice packets to acknowledge that the voice data are actually transmitted from a supported IP-based PBX extension, that is, the IP-based PBX extension 50a. Similarly, the host 12 can also communicate with the IP-based PBX extension 50a through the above-mentioned virtual IP address of the IP-based PBX extension 50a, the above-mentioned dynamic IP address of the xDSL 36a, and the above-mentioned static IP address of the xDSL modem 16.

Please note that the IP-based PBX extensions 20 can be connected to the local host by cables according to the IEEE 802.3 protocol or be wirelessly connected to the local host through the AP 18 according to the IEEE 802.11x protocol. As shown in FIG. 2, an available local connection means is checked first (steps 101, 110, 112). If the available local connection means is found, an activated IP-based PBX extension can directly communicate with the host 12 without the help of the Internet 15.

In contrast to the prior art, the claimed method and the claimed telecommunication system of routing data outputted from IP-based PBX extensions to the host can transmit voice packets to the Internet through virtual IP addresses. The virtual IP addresses provided by the IP sharing device are cheaper than the physical IP addresses provided by the ISP. In addition, the claimed method and the claimed telecommunication system greatly improve flexibility of prior art VoIP systems through transmitting voice packets efficiently via the Internet with the help of virtual IP addresses.

Those skilled in the art will readily observe that numerous modifications and alterations of the device may be made while retaining the teachings of the invention. Accordingly, that above disclosure should be construed as limited only by the metes and bounds of the appended claims.

1. A method of routing a data of an IP-based PBX extension to a host comprising:
(a) driving the IP-based PBX extension to request a virtual IP address from an IP sharing device;
(b) driving the IP-based PBX extension having the virtual IP address to output a packet having the data through the IP sharing device;
(c) utilizing a sender with a first IP address to deliver the packet received from the IP sharing device to the host with a second IP address through a computer network; and
(d) utilizing the host to extract the data from the packet.

2. The method of claim 1 wherein step (a) further comprises utilizing either a wired transmission protocol or a wireless transmission protocol to access the IP sharing device for requesting the virtual IP address.

3. The method of claim 2 further comprising:
before step (a) is performed, checking if the IP-based PBX extension is capable of accessing the IP sharing device through the wired transmission protocol;
wherein if the IP-based PBX extension is capable of accessing the IP sharing device through the wired transmission protocol, the IP-based PBX extension utilizes the IEEE 802.3 protocol for requesting the virtual IP address, and if the IP-based PBX extension is not capable of accessing the IP sharing device through the wired transmission protocol, the IP-based PBX extension utilizes the wireless transmission protocol for requesting the virtual IP address.

4. The method of claim 3 wherein the wired transmission protocol is an IEEE 802.3 protocol, and the wireless transmission protocol is an IEEE 802.11x protocol.

5. The method of claim 1 wherein the IP sharing device is a dynamic host configuration protocol (DHCP) server or a network address translation (NAT) server.

6. The method of claim 2 wherein step (a) further comprises utilizing an access point (AP) for bridging the IP-based PBX extension and the IP sharing device through the wireless transmission protocol, and the IP-based PBX extension is in wireless communication with the AP.

7. The method of claim 1 wherein step (b) further comprises adding the virtual IP address to the packet.

8. The method of claim 1 wherein the computer network is an Internet network.

9. A telecommunication system comprising:
an IP sharing device for providing a virtual IP address;
an IP-based PBX extension electrically connected to the IP sharing device for requesting the virtual IP address from the IP sharing device device, wherein the IP-based PBX extension having the virtual IP address is capable of outputting a packet having the data through the IP sharing device device;
a host; and
a sender electrically connected to the IP sharing device device, the sender with a first IP address capable of delivering the packet received from the IP sharing device to the host with a second IP address through a computer network;
wherein the host extracts the data from the packet.

10. The telecommunication system of claim 9 wherein the IP-based PBX extension utilizes either a wired transmission protocol or a wireless transmission protocol to access the IP sharing device for requesting the virtual IP address.

11. The telecommunication system of claim 10 wherein before requesting the virtual IP address, the IP-based PBX extension checks if the IP-based PBX extension is capable of accessing the IP sharing device through the wired transmission protocol, wherein if the IP-based PBX extension is capable of accessing the IP sharing device through the wired transmission protocol, the IP-based PBX extension utilizes the IEEE 802.3 protocol for requesting the virtual IP address, and if the IP-based PBX extension is not capable of accessing the IP sharing device through the wired transmission protocol, the IP-based PBX extension utilizes the wireless transmission protocol for requesting the virtual IP address.

12. The telecommunication system of claim 11 wherein the wired transmission protocol is an IEEE 802.3 protocol, and the wireless transmission protocol is an IEEE 802.11x protocol.

13. The telecommunication system of claim 9 wherein the IP sharing device is a dynamic host configuration protocol (DHCP) server or a network address translation (NAT) server.

14. The telecommunication system of claim 10 further comprising an access point (AP) electrically connected to the IP-based PBX extension and the IP sharing device through the wireless transmission protocol, and the IP-based PBX extension is in wireless telecommunication with the AP.

15. The telecommunication system of claim 9 wherein the IP-based PBX extension adds the virtual IP address to the packet.

16. The telecommunication system of claim 9 wherein the computer network is an Internet network.

17. The telecommunication system of claim 9 wherein the sender is an xDSL modem or a cable modem.
